(19) United States
(12) Patent Application Publication
(10) Pub. No.: US 2012/0169756 A1
(43) Pub. Date: Jul. 5, 2012

(54) IMAGE PROCESSING DEVICE, IMAGE PROCESSING METHOD, AND PROGRAM

(75) Inventor: Sakuichi Ohtsuka, Kagoshima (JP)

(73) Assignee: KAGOSHIMA UNIVERSITY, Kagoshima (JP)

(21) Appl. No.: 13/395,056

(22) PCT Filed: Sep. 9, 2010
(86) PCT No.: PCT/JP2010/065490

§ 371 Date: Mar. 8, 2012

(30) Foreign Application Priority Data
Sep. 9, 2009 (JP) 2009-208560

(51) Int. Cl. G09G 5/02

(52) U.S. Cl. 345/589

(57) ABSTRACT

A hue conversion unit (124) converts a value of a first color difference (i.e., chrominance) signal (color difference signal of color pair hard to be distinguished by dichromat) obtained by a luminance signal/color difference signal conversion unit (123) into a value of a second color difference signal (color difference signal of color pair easy to be distinguished by dichromat), and converts a value of the second color difference signal obtained by the luminance signal/color difference signal conversion unit (123) into a value of the first color difference signal. A hue-converted color image generation unit (127) generates a hue-converted color image based on a luminance signal and the first color difference signal after conversion and the second color difference signal after conversion which are obtained by the hue conversion unit (124). Then, an image displaying control unit (129) performs control to alternatively display an original color image and the hue-converted color image in a display section (107) in a manner to be able to be visually perceived by the dichromat at the same viewpoint.

### TECHNICAL FIELD

The present invention relates to an image processing device and image processing method for performing a processing of an original color image, and a program for causing a computer to execute the image processing method.

### BACKGROUND ART

Conventionally, in order to provide an image easy to be distinguished also by what is called a color deficient person, a technique for performing an image processing to an original color image (also called an original image) has been suggested. For example, Patent Literature 1 below describes a technique for extracting a pixel region (image region) of a hue hard to be distinguished by a color deficient person from an original color image and converting the hue of the image region into a hue easy to be distinguished by the color deficient person.

### CITATION LIST

### Patent Literature

Patent Literature 1: Japanese Laid-open Patent Publication No. 2008-33489

### SUMMARY OF INVENTION

### Technical Problem

However, in the technique of aforementioned Patent Literature 1, since a processing of extracting a desired part of the image region among the original color image is performed, there is a problem that a processing load of an image processing in the original color image is increased.

The present invention is made in view of such a problem, and an object thereof is to provide a mechanism enabling a color deficient person (dichromat) to grasp a hue of an original color image while suppressing a processing load of an image processing in the original color image.

### Solution to Problem

An image processing device of the present invention is an image processing device performing a processing of an original color image and performing control to alternatively display at least two kinds of images including the original color image in a manner to be able to be visually perceived by a dichromat at the same viewpoint, the image processing device includes: a first conversion unit converting the original color image into a luminance signal, a first color difference (i.e., chrominance) signal being a color difference signal of a color pair hard to be distinguished by the dichromat, and a second color difference signal being a color difference signal of a color pair easy to be distinguished by the dichromat; a second conversion unit performing hue conversion of converting a value of the first color difference signal obtained by a conversion processing by the first conversion unit into a value of the second color difference signal and converting a value of the second color difference signal obtained by the conversion processing by the first conversion unit into a value of the first color difference signal; an image generation unit generating a hue-converted color image based on the luminance signal obtained by the conversion processing by the first conversion unit and the first color difference signal after conversion and the second color difference signal after conversion which are obtained by a conversion processing by the second conversion unit; and an image displaying control unit performing control to alternatively display the original color image and the hue-converted color image in a manner to be able to be visually perceived by the dichromat at the same viewpoint.

An image processing method of the present invention is an image processing method by an image processing device performing a processing of an original color image and performing control to alternatively display at least two kinds of images including the original color image in a manner to be able to be visually perceived by a dichromat at the same viewpoint, the method includes the steps of: first converting of converting the original color image into a luminance signal, a first color difference signal being a color difference signal of a color pair hard to be distinguished by the dichromat, and a second color difference signal being a color difference signal of a color pair easy to be distinguished by the dichromat; second converting of performing hue conversion of converting a value of the first color difference signal obtained by a conversion processing by the first converting into a value of the second color difference signal and converting a value of the second color difference signal obtained by the conversion processing by the first converting into a value of the first color difference signal; image generating of generating a hue-converted color image based on the luminance signal obtained by the conversion processing by the first converting and the first color difference signal after conversion and the second color difference signal after conversion which are obtained by a conversion processing by the second converting; and image displaying controlling of performing control to alternatively display the original color image and the hue-converted color image in a manner to be able to be visually perceived by the dichromat at the same viewpoint.

A program product of the present invention is a program product for causing a computer to execute an image processing method by an image processing device performing a processing of an original color image and performing control to alternatively display at least two kinds of images including the original color image in a manner to be able to be visually perceived by a dichromat at the same viewpoint, the program product includes: computer readable code means for executing first converting of converting the original color image into a luminance signal, a first color difference signal being a color difference signal of a color pair hard to be distinguished by the dichromat, and a second color difference signal being a color difference signal of a color pair easy to be distinguished by the dichromat; computer readable code means for executing second converting of performing hue conversion of converting a value of the first color difference signal obtained by a conversion processing by the first converting into a value of the second color difference signal and converting a value of the second color difference signal obtained by the conversion processing by the first converting into a value of the first color difference signal; computer readable code means for executing image generating of generating a hue-converted color image based on the luminance signal obtained by the conversion processing by the first converting and the first color difference signal after conversion and the second color difference signal after conversion which are obtained by a conversion processing by the second converting; and computer readable code means for executing image displaying controlling of performing control to alternatively display the original color image and the hue-converted color image in a manner to be able to be visually perceived by the dichromat at the same viewpoint.

### Advantageous Effects of Invention

According to the present invention, it is possible to provide a mechanism enabling a color deficient person (dichromat) to grasp a hue of an original color image while suppressing a processing load of an image processing in the original color image.

### BRIEF DESCRIPTION OF DRAWINGS

FIG. 1 is a block diagram indicating an example of a hardware configuration of an image capturing device (image processing device) according to an embodiment of the present invention;

FIG. 2 is a block diagram indicating a functional configuration of the image capturing device (image processing device) according to the embodiment of the present invention;

FIG. 3 indicates the embodiment of the present invention, and is a schematic diagram indicating a hue circle and an example of a reference color difference first axis based on a first color difference signal and a reference color difference second axis based on a second color difference signal set in the hue circle;

FIG. 4A indicates the embodiment of the present invention, and is a schematic diagram indicating a schematic configuration example of a hue conversion unit and a color compression processing unit indicated in FIG. 2;

FIG. 4B is a table indicating a correspondence among respective signals of an NTSC system, an MPEG system, and an L*a*b* system;

FIG. 5 is a flowchart indicating an example of a processing procedure of an image processing method by the image capturing device (image processing device) according to the embodiment of the present invention;

FIG. 6 indicates the embodiment of the present invention, and is a schematic diagram indicating an example of an original color image acquired in a step S501 of FIG. 5;

FIG. 7 indicates the embodiment of the present invention, and is a schematic diagram indicating an example of the original color image at a time that a dichromat of Type-P (Protanopia)/Type-D (Deuteranopia) observes the original color image indicated in FIG. 6;

FIG. 8A indicates the embodiment of the present invention, and is a schematic diagram indicating an example of a hue-converted color image generated in a step S506 of FIG. 5 when a hue conversion processing in a step S503 of FIG. 5 is performed and a color compression processing in a step S505 of FIG. 5 is not performed;

FIG. 8B indicates the embodiment of the present invention, and is a schematic diagram indicating an example of a hue-converted color image generated in the step S506 of FIG. 5 when the hue conversion processing in the step S503 of FIG. 5 is performed and the color compression processing in the step S505 of FIG. 5 is performed;

FIG. 9 indicates the present embodiment, and is a schematic diagram indicating an example of a hue-converted color image at a time that a dichromat of Type-P/Type-D observes the hue-converted color image indicated in FIG. 8A or the hue-converted color image indicated in FIG. 8B; and

FIG. 10 indicates the embodiment of the present invention, and is a schematic diagram illustrating an example of a state in which the original color image and the hue-converted color image are alternatively displayed in a display section by an image displaying control processing in a step S507 of FIG. 5.

### DESCRIPTION OF EMBODIMENTS

Hereinafter, a mode (embodiment) to implement the present invention will be described with reference to the drawings. More specifically, in the following explanation of the embodiment, am example in which an image capturing device (including both a device to capture a still image and a device to capture a moving image) is applied as an image processing device according to the present invention will be described.

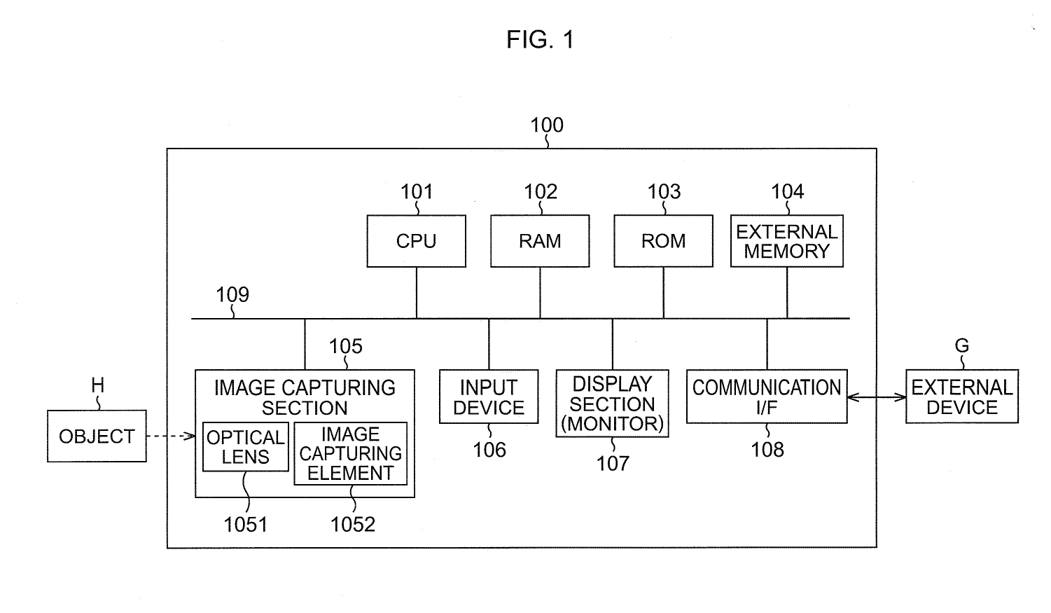

FIG. 1 is a block diagram indicating an example of a hardware configuration of an image capturing device (image processing device) 100 according to the embodiment of the present invention.

As indicated in FIG. 1, the image capturing device 100 is constituted to have a hardware configuration of a CPU 101, a RAM 102, a ROM 103, an external memory 104, an image capturing section 105, an input device 106, a display section 107, a communication interface (communication I/F) 108, and a bus 109.

The CPU 101 controls the entire image capturing device 100 by using a program or data stored in the ROM 103 or the external memory 104, for example.

The RAM 102 is constituted by an SDRAM, a DRAM or the like, and has an area in which a program or data loaded from the ROM 103 or the external memory 104 is temporarily stored, and has a work area necessary for the CPU 101 to perform various processings.

The ROM 103 stores a program unnecessary to be changed, information such as various parameters or the like.

The external memory 104 stores, for example, an operating system (OS) and a program the CPU 101 executes, and further, information regarded to be known in the explanation of the present embodiment. It should be noted that in the present embodiment a program for executing a processing according to the embodiment of the present invention is to be stored in the external memory 104, but a mode is also applicable in which the program is stored in the ROM 103, for example.

The image capturing section 105 captures an optical image of an object H as a color image. More specifically, the image capturing section 105 is constituted to have an optical lens 1051 to lead the optical image from the object H to an image capturing element 1052 inside and the image capturing element 1052 capturing the optical image of the object H led via the optical lens 1051 as the color image (hereinafter, referred to as “original color image”).

The input device 106 is constituted by, for example, a switch and a button equipped in the image-capturing device 100, a transparent touch panel provided on the display section 107, and the like. The input device 106 is operated when a user performs various instructions to the image capturing device 100, for example, and inputs the instruction into the CPU 101 and the like.

The display section 107 is constituted to have, for example, a monitor and the like, and outputs various images and various information to a monitor based on control of the CPU 101.

The communication I/F 108 commands transmission/reception of various information and the like between the image capturing device 100 and an external device G.

The bus 109 connects the CPU 101, the RAM 102, the ROM 103, the external memory 104, the image capturing section 105, the input device 106, the display device 107, and the communication I/F 108 in a manner to be able to communicate with each other.

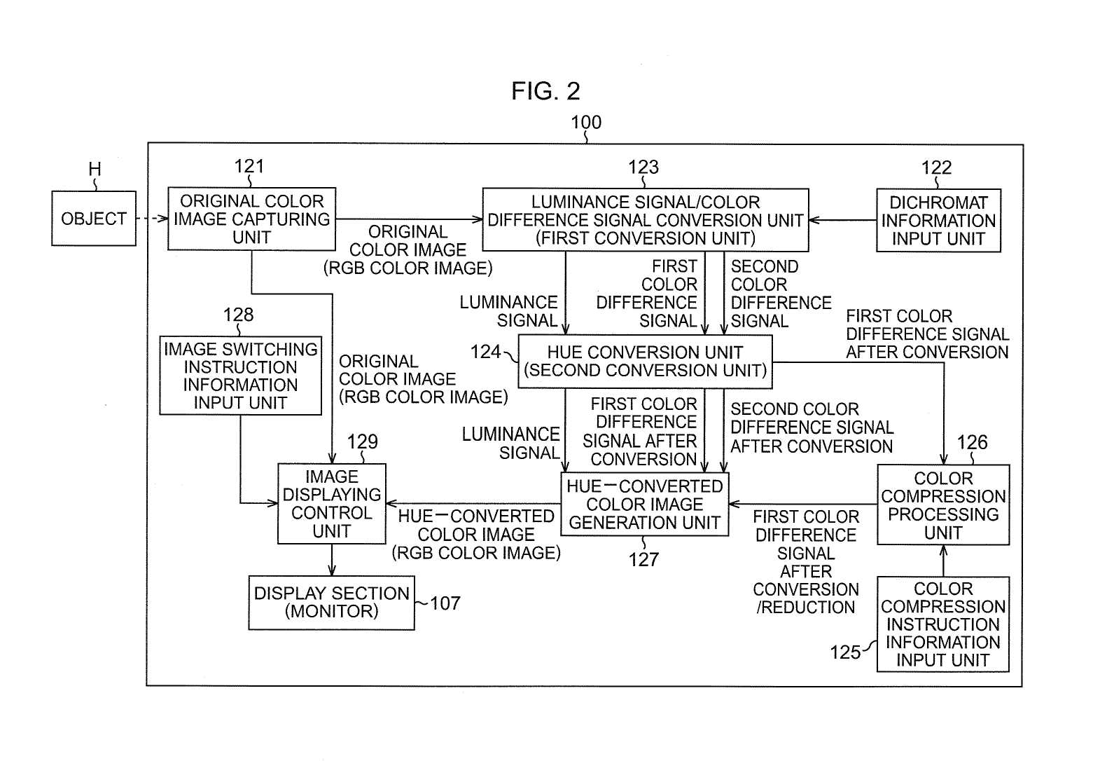

FIG. 2 is a block diagram indicating an example of a functional configuration of the image capturing device (image processing device) 100 according the embodiment of the present invention. In FIG. 2, the same reference number is given to a configuration in terms of a function the same as the configuration illustrated in FIG. 1.

As illustrated in FIG. 2, the image capturing device 100 is constituted to have a functional configuration of an original color image capturing unit 121, a dichromat information input unit 122, a luminance signal/color difference signal conversion unit 123, a hue conversion unit 124, a color compression instruction information input unit 125, a color compression processing unit 126, a hue-converted color image generation unit 127, an image switching instruction information input unit 128, an image displaying control unit 129, and the display section 107.

Here, an example of a correspondence between the hardware configuration of the image capturing device 100 indicated in FIG. 1 and the functional configuration of the image capturing device 100 indicated in FIG. 2 will be indicated below.

For example, the original color image capturing unit 121 indicated in FIG. 2 is constituted from the image capturing section 105 indicated in FIG. 1. Further, for example, the dichromat information input unit 122, the color compression instruction information input unit 125, and the image switching instruction information input unit 128 indicated in FIG. 2 are constituted from the input device 106 indicated in FIG. 1. Further, for example, the luminance signal/color difference signal conversion unit 123, the hue conversion unit 124, the color compression processing unit 126, the hue-converted color image generation unit 127, and the image displaying control unit 129 which are indicated in FIG. 2 are constituted from the CPU 101, the program stored in the external memory 104, and the RAM 102 indicated in FIG. 1.

It should be noted that though in the aforementioned example the mode in which each functional configuration of 123, 124, 126, 127, and 129 indicated in FIG. 2 is implemented by the CPU 101 indicated in FIG. 1 executing the program stored in the external memory 104 is explained, the present invention is not limited to this mode. For example, a mode in which each functional configuration of 123, 124, 126, 127, and 129 indicated in FIG. 2 is formed by an independent hardware configuration respectively is also applicable to the present invention.

Subsequently, each functional configuration indicated in FIG. 2 will be described.

The original color image capturing unit 121 captures an original color image (original image) of the object H based on the optical image of the object H.

The dichromat information input unit 122 performs input of dichromat information related a type of a dichromat who visually perceives the original color image.

The luminance signal/color difference signal conversion unit 123 performs a processing of converting the original color image acquired by the image capturing processing by the original color image capturing unit 121 into a luminance signal, a first color difference signal being a color difference signal of a color pair hard to be distinguished by the dichromat visually recognizing the original color image, and a second color difference signal being a color difference signal of a color pair easy to be distinguished by the dichromat visually recognizing the original color image. The luminance signal/color difference signal conversion unit 123 constitutes a “first conversion unit”.

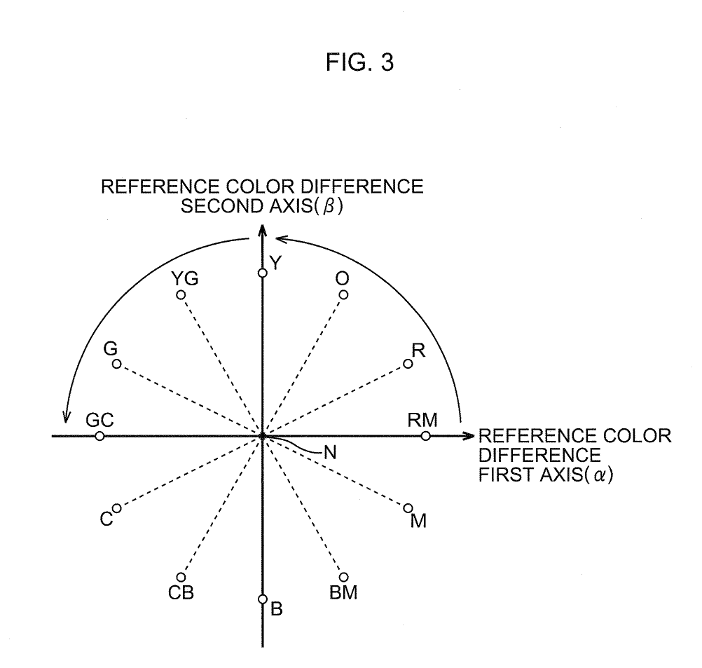

More specifically, the luminance signal/color difference signal conversion unit 123 sets the first color difference signal and the second color difference signal to be converted, in correspondence with dichromat information having been inputted by the dichromat information input unit 122. Setting of the first color difference signal and the second color difference signal by the luminance signal/color difference signal 123 will be described by using FIG. 3.

FIG. 3 indicates the embodiment of the present invention, and is a schematic diagram indicating a hue circle and an example of a reference color difference first axis based on the first color difference signal and a reference color difference second axis based on the second color difference signal set in the hue circle.

More specifically, FIG. 3 indicates an example of a reference color difference first axis (α) based on the first color difference signal and a reference color difference second axis (β) based on the second color difference signal which are set in the hue circle, in a case of the dichromat (what is called Type-P dichromat and Type-D dichromat, in terms of type of dichromat) who has difficulty in distinguishing red and green. The hue circle indicated in FIG. 3 indicates 12 colors in total, that is, in addition to three primary colors (R (red), G (green), B (blue)) by additive color mixture and three primary colors (C (cyan), M (magenta), Y (yellow)) by subtractive color mixture, there are added 6 colors (RM (pink/red-magenta), O (orange), YG (yellow-green), GC (green-cyan), CB (cyan-blue (sky blue)), BM (bluish magenta (blue-violet)) positioned in the middle of the respective primary colors). Further, an intersection (that is, origin of coordinates of hue circle) of the reference color difference first axis (α) and the reference color difference second axis (β) in the hue circle is N, that is, neutral gray.

In the hue circle indicated in FIG. 3, a hue belonging to the reference color difference first axis is represented by a value of the first color difference signal, a hue belonging to the reference color difference second axis is represented by a value of the second color difference signal, and a hue belonging neither of the reference color difference first axis nor the reference color difference second axis is represented by a value of both components of the aforementioned first color difference signal and second color difference signal. Further, FIG. 3 indicates the hue circle defined by the first color difference signal and the second color difference signal, and an axis of the luminance signal is set through the intersection of the reference color difference first axis and the reference color difference second axis in a vertical direction in relation to a sheet.

Here, the hue circle indicated in FIG. 3 is one indicating an example of a color space defined in the present embodiment, and further, in the present invention another general color space can be applied, and a mode in which a first axis based on a first color difference signal and a second axis based on a second color difference signal are set by using that another general color space is also applicable.

In general, the primary color R in various color spaces is red with a tinge of yellow (that is, vermilion). Normally, a trichromat (normal color vision person) grasps a hue as if synthesizing color differences of two axes, and a color difference axis (RM-GC) defined as the reference color difference first axis (α) indicated in FIG. 3 is equivalent to what is called a red-green (or red-cyan) axis, and is estimated by averaging mixed color lines of the dichromat. Further, a color difference axis (Y-B) defined as the reference color difference second axis (β) orthogonal to the reference color difference first axis (α) is equivalent to what is called a yellow-blue line.

In the present embodiment, when the dichromat information related to the type of the dichromat inputted by the dichromat information input unit 122 is information of, for example, the aforementioned Type-P dichromat or Type-D dichromat, the luminance signal/color difference signal conversion unit 123 designates, for example, RM and GC indicated in FIG. 3 as a color pair hard to be distinguished by the dichromat, and sets a color difference signal (RM-GC) being a color difference signal related to the RM and GC as a first color difference signal and sets a color difference axis based on the color difference signal (RM-GC) as a reference color difference first axis (α). Further, in such a case, the luminance signal/color difference signal conversion unit 123 designates Y and B indicated in FIG. 3 as a color pair easy to be distinguished by the dichromat, setting a color difference signal (Y-B) being a color difference signal related to the Y and B as a second color difference signal and setting a color difference axis based on the color difference signal (Y-B) as a reference color difference second axis (β). On this occasion, in the hue circle indicated in FIG. 3, the reference color difference first axis (α) and the reference color difference second axis (β) are orthogonal (angle is 90°) to each other.

Further, when the dichromat information related to the type of the dichromat inputted by the dichromat information input unit 122 is, for example, information of a dichromat (what is called Type-T (Tritanopia) dichromat in terms of type of dichromat) who has difficulty in distinguishing yellow and blue-violet, the luminance signal/color difference signal conversion unit 123 designates, for example, Y and B indicated in FIG. 3 as a color pair hard to be distinguished by the dichromat, and in such a case, sets a color difference signal (Y-B) being a color difference signal related to the Y and B as a first color different signal though different from one indicated in FIG. 3 in this case, and sets a color difference axis based on the color difference signal (Y-B) as a reference color difference first axis (α). Further, in such a case, the luminance signal/color difference signal conversion unit 123 designates GC and RM indicated in FIG. 3 as a color pair easy to be distinguished by the dichromat, and sets a color difference signal (GC-RM) being a color difference signal related to the GC and RM as a second color difference signal though different from one indicated in FIG. 3 in this case, and sets a color difference axis based on the color difference signal (GC-RM) as a reference color difference second axis (β). On this occasion also, the reference color difference first axis (α) and the reference color difference second axis (β) are orthogonal (angle is 90°) to each other.

Here, FIG. 2 will be explained again.

The hue conversion unit 124 converts a value of the first color difference signal obtained by a conversion processing by the luminance signal/color difference signal conversion unit 123 into a value of the second color difference signal and performs hue conversion of converting a value of the second color difference signal obtained by a conversion processing by the luminance signal/color difference signal conversion unit 123 into a value of the first color difference signal. An image of the processings of the hue conversion unit 124 is an image of processings indicated by arrows in the hue circle of FIG. 3. Further, the hue conversion unit 124 constitutes a “second conversion unit”.

The color compression instruction information input unit 125 performs input of color compression instruction information into the color compression processing unit 126 when a color compression processing by the color compression processing unit 126 is to be performed.

The color compression processing unit 126 reduces the value of the first color difference signal after conversion obtained by the conversion processing by the hue conversion unit 124 and performs a color compression processing related to the hue of the hue circle indicated in FIG. 3, when the color compression instruction information is inputted from the color compression instruction information input unit 125.

The hue-converted color image generation unit 127 performs an RGB re-conversion processing based on the luminance signal obtained by the conversion processing by the luminance signal/color difference signal conversion unit 123 and the first color difference signal after conversion and the second color difference signal after conversion which are obtained by the conversion processing by the hue conversion unit 124, thereby to perform a processing of generating a hue-converted color image. Further, when the color compression processing is performed in the color compression processing unit 126, the hue-converted color image generation unit 127 performs a processing of generating a hue-converted color image by using the luminance signal obtained by the conversion processing by the luminance signal/color difference signal conversion unit 123, the first color difference signal after conversion/reduction (after color compression) obtained by the color compression processing by the color compression processing unit 126, and the second color difference signal after conversion obtained by the conversion processing by the hue conversion unit 124. Here, a “first color difference signal after conversion/reduction (after color compression)” means a first color difference signal after being converted in the hue conversion unit 124 and subjected to a reduction processing (color compression processing) in the color compression processing unit 126.

The image switching instruction information input unit 128 inputs image switching instruction information into the image displaying control unit 129 when a switching processing of a display image (original color image/hue-converted color image) to the display section 107 by the image displaying control unit 129 is to be performed.

The image displaying control unit 129 performs control to alternatively display the original color image and the hue-converted color image in the display section 107 in a manner to be able to be visually perceived by the dichromat related to the dichromat information inputted from the dichromat information input unit 122 at the same viewpoint.

Next, a configuration example of the hue conversion unit 124 and the color compression processing unit 126 indicated in FIG. 2 will be described.

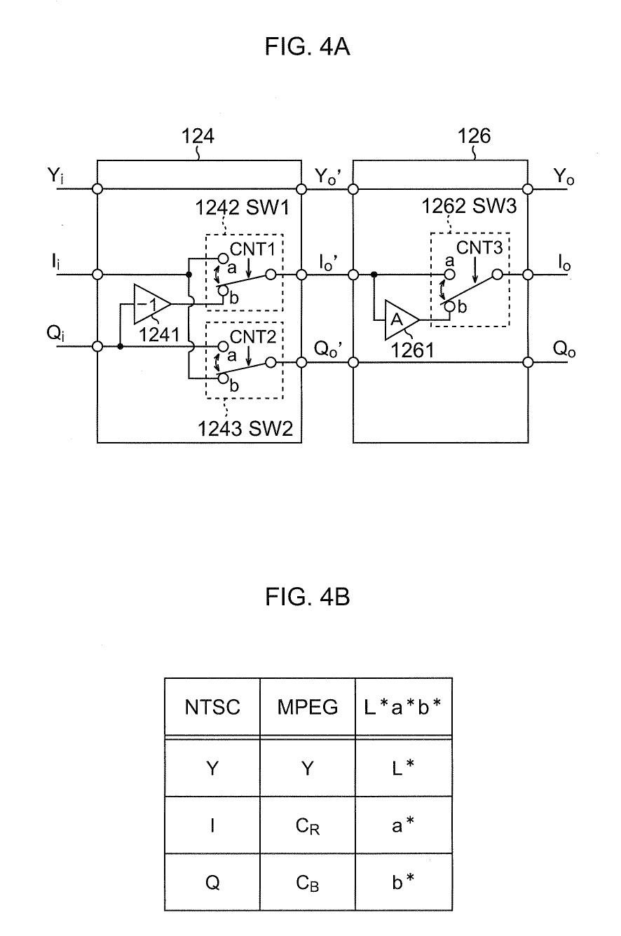

FIG. 4A illustrates the embodiment of the present invention and is a schematic diagram indicating a schematic configuration example of the hue conversion unit 124 and the color compression processing unit 126 which are indicated in FIG. 2.

Here, in FIG. 4A, an example of a luminance signal and a color difference signal in an NTSC system is illustrated, and Y corresponds to a luminance signal in the present embodiment, I corresponds to a first color difference signal in the present embodiment, and Q corresponds to a second color difference signal in the present embodiment. Further, a subscript i added to an alphabetical character indicating each signal depicts input and a subscript o depicts output.

As illustrated in FIG. 4A, the hue conversion unit 124 is constituted to have an amplifier (converter) 1241 whose gain is −1, a first switch SW1 (1242), and a second switch SW2 (1243). Here, in the hue conversion unit 124, when the aforementioned hue conversion processing is to be performed, the first switch SW1 (1242) is connected to a terminal b side by a control signal CNT1, and the second switch SW2 (1243) is connected to the terminal b side by a control signal CNT2. Thereby, a value of a color difference signal Iᵢ being a first color difference signal outputted from the luminance signal/color difference signal conversion unit 123 is converted into a value of a color difference signal Qₒ′ being a second color difference signal, and a value of a color difference signal Qᵢ being a second color difference signal outputted from the luminance signal/color difference signal conversion unit 123 is converted into a value of a color difference signal Iₒ′ being a first color difference signal. On this occasion, a luminance signal Yᵢ outputted from the luminance signal/color difference signal conversion unit 123 is outputted as a luminance signal Yₒ′ as it is.

Further, as indicated in FIG. 4A, the color compression processing unit 126 is constituted to have an amplifier (attenuator) 1261 whose gain is A (0≦|A|<<1) and a third switch SW3 (1262). Here, when the aforementioned color compression processing is to be performed in the color compression processing unit 126, the third switch SW3 (1262) is connected to the terminal b side by a control signal CNT3. Hereby, the color difference signal Iₒ after reduction (after color compression) in which the value of the color difference signal being the first color difference signal after conversion outputted from the hue conversion unit 124 is reduced by A times is outputted. On this occasion, the luminance signal Yₒ′ outputted from the hue conversion unit 124 is outputted as the luminance signal Yₒ as it is and the color difference signal Qₒ′ being the second color difference signal after conversion outputted from the hue conversion unit 124 is outputted as the luminance signal Qₒ as it is.

It should be noted that if the third switch SW3 (1262) is connected to a terminal a side by the control signal CNT3, the color compression processing by the color compression processing unit 126 is not performed.

In other words, the color compression processing unit 126 performs a processing in which if the color compression instruction information is inputted from the color compression instruction information input unit 125 by the control signal CNT3, the third switch SW3 (1262) is connected to the terminal b side thereby to perform the color compression processing and if the color compression instruction information is not inputted from the color compression instruction information input unit 125, the third switch SW3 (1262) is connected to the terminal a side thereby not to perform a color compression processing.

It should be noted that though in the example indicated in FIG. 4A the example of the signal in the NTSC system is described, the present invention is not limited to that mode. For example, as indicated in FIG. 4B, a mode in which a signal in the MPEG system or the L*a*b* system other than the NTSC system is used is also applicable. FIG. 4B indicates a correspondence among the respective signals in such a case.

Next, a processing procedure of an image processing method by the image capturing device (image processing device) 100 according to the embodiment of the present invention will be described.

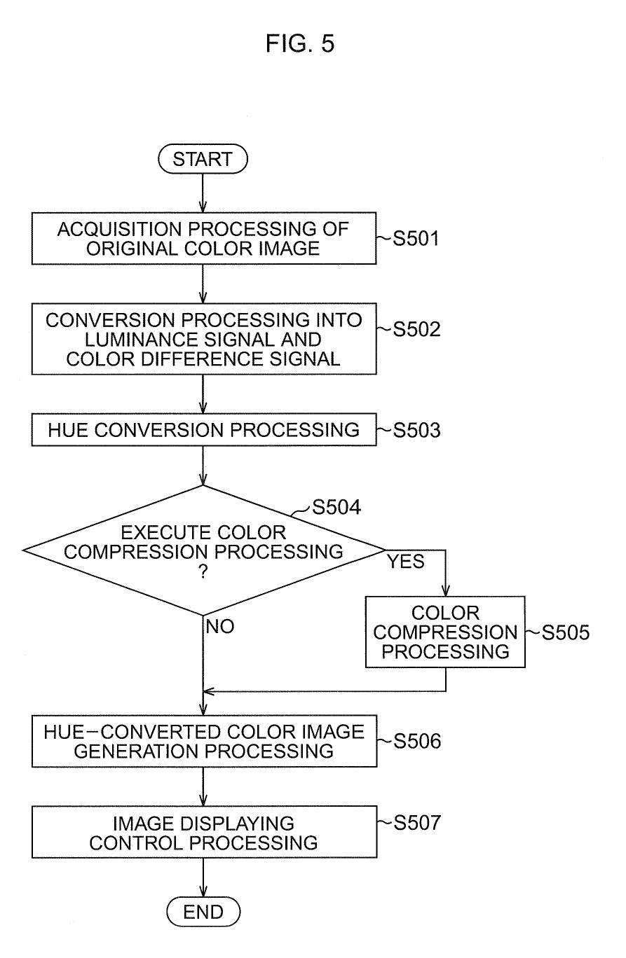

FIG. 5 is a flowchart indicating an example of a processing procedure of the image processing method by the image capturing device (image processing device) 100 according to the embodiment of the present invention.

First, in a step S501 of FIG. 5, the original color image capturing unit 121 performs a processing of capturing the original color image of the object H based on the optical image of the object H and acquiring the original color image of the object H. Here, the original color image acquired in the step S501 is presumed to be an RGB color image.

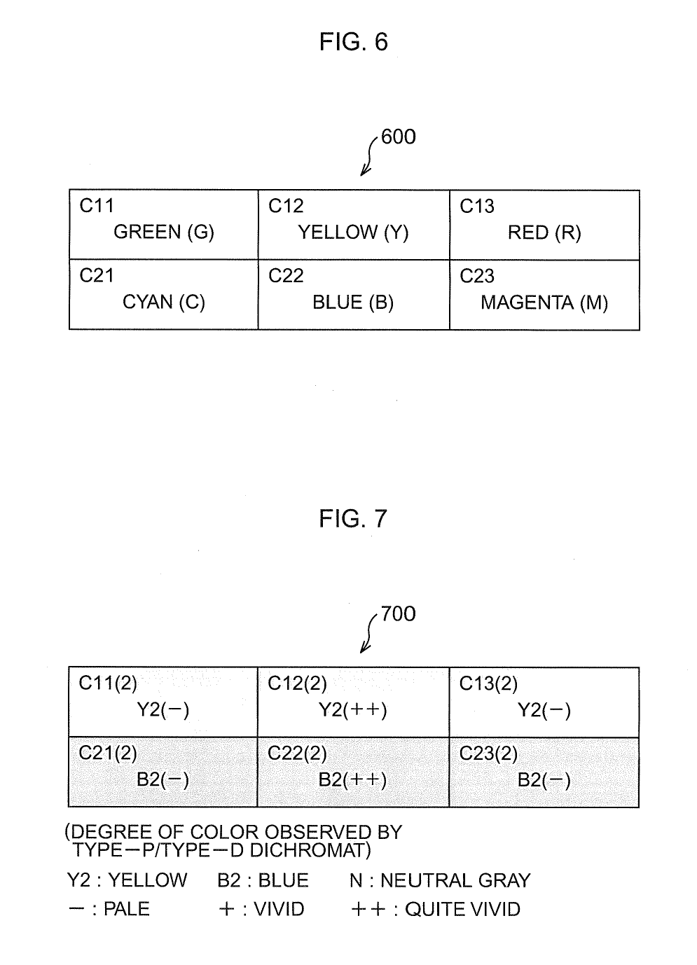

FIG. 6 indicates the embodiment of the present invention and is a schematic diagram indicating an example of an original color image 600 acquired in the step S501 of FIG. 5.

Here, FIG. 6 indicates an example of an original color image captured by using what is called a color patch as an object H. As indicated in FIG. 6, in the original color image 600, six kinds of color patches, i.e., a color patch C11 of green (G), a color patch C12 of yellow (Y), a color patch C13 of red (R), a color patch C21 of cyan (C), a color patch C22 of blue (B), and a color patch C23 of magenta (M) are indicated.

A trichromat (normal color vision person) perceives, in the original color image 600, the color patch C11 of green (G) and the color patch C21 of cyan (C) which are positioned in a left side as colors with a tinge of green collectively, and the color patch C13 of red (R) and the color patch C23 of magenta (M) which are positioned in a right side as colors with a tinge of red collectively, and focuses attention on a contrast of those colors. Next, as a color pair independent of the above the trichromat focuses attention on a color contrast of yellow and blue for a color pair of the color patch C12 of yellow (Y) and the color patch C22 of blue (B).

FIG. 7 indicates the present embodiment, and is a schematic diagram indicating an example of an original color image 700 at a time that a Type-P/Type-D dichromat observes the original color image 600 indicated in FIG. 6. Here, since FIG. 7 indicates color patches reflected in the eyes of the Type-P/Type-D dichromat, (2) is added to the respective color patches indicated in FIG. 6 for discrimination, as a color patch C11(2) for the color patch C11 indicated in FIG. 6.

As described above, since the Type-P/Type-D dichromat has difficulty in distinguishing red from green, the original color image 600 indicated in FIG. 6 is reflected in the eyes of the dichromat as the original color image 700 indicated in FIG. 7.

More specifically, in the eyes of the Type-P/Type-D dichromat, the color patch C11 of green (G) indicated in FIG. 6 is reflected as the color patch C11(2) of pale yellow (Y2(−)) indicated in FIG. 7, the color patch C12 of yellow (Y) indicated in FIG. 6 is reflected as a color patch C12(2) of quite vivid yellow (Y2(++)) indicated in FIG. 7, and the color patch C13 of red (R) indicated in FIG. 6 is reflected as a color patch C13(2) of pale yellow (Y2(−)) indicated in FIG. 7. Further, in the eyes of the Type-P/Type-D dichromat, the color patch C21 of cyan (C) indicated in FIG. 6 is reflected as a color patch C21(2) of pale blue (B2(−)) indicated in FIG. 7, the color patch C22 of blue (B) indicated in FIG. 6 is reflected as a color patch C22(2) of quite vivid blue (B2(++)) indicated in FIG. 7, and the color patch C23 of magenta (M) indicated in FIG. 6 is reflected as a color patch C23(2) of pale blue (B2(−)) indicated in FIG. 7. In FIG. 7, a subscript 2 in Y2 is added to mean yellow classified by a dichromat, and similarly, a subscript 2 in B2 is added to mean blue classified by the dichromat.

As described above, while a trichromat (normal color vision person) first pays attention to contrasts of colors of the color patches (C11, C13, C21, C23 of FIG. 6) disposed in the right and the left, in a case of a Type-P/Type-D dichromat, the three color patches (C11 to C13 of FIG. 6) disposed in the upper part are each perceived as a color with a tinge of yellow as depicted as Y2 in FIG. 7, the three color patches (C21 to C23 of FIG. 6) disposed in the lower part are each perceived as a color with a tinge of blue as depicted as B2 in FIG. 7. As described above, while the trichromat (normal color vision person) pays attention to a difference of colors in a right and left direction, in the case of the Type-P/Type-D dichromat, perception is that of a difference in colors in an up and down direction deviating 90 degrees. Further, the color pair of the color patches C11(2) and C13(2) and the color pair of the color patches of C21(2) and C23(2) which are perceived by the Type-P/Type-D dichromat can be clearly distinguished as a color pair of green and red in a broad sense of a term as indicated in FIG. 6 in a case of the trichromat (normal color vision person), but are hard to be distinguished or becomes a mixed color in the case of the dichromat.

Here, FIG. 5 will be explained again.

When the processing of the step S501 in FIG. 5 is finished, the process is proceeded to a step S502.

When the process is proceeded to the step S502, in correspondence with the dichromat information inputted by the dichromat information input unit 122, the luminance signal/color difference signal conversion unit 123 performs a processing of converting the original color image 600 acquired in the step S501 into the luminance signal, the first color difference signal being the color difference signal of the color pair hard to be distinguished by the dichromat based on the dichromat information, and the second color difference signal being the color difference signal of the color pair easy to be distinguished by the dichromat based on the dichromat information.

More specifically, in the step S502, a processing is performed in which, in a case that the dichromat information related to the type of the dichromat inputted by the dichromat information input unit 122 is information of the aforementioned Type-P dichromat or the Type-D dichromat, the original color image 600 acquired in the step S501 is converted into a luminance signal, a first color difference signal corresponding to the color difference axis (RM-GC) defined as the reference color difference first axis (α) indicated in FIG. 3, and a second color difference signal corresponding to the color difference axis (Y-B) defined as the reference color difference second axis (β) indicated in FIG. 3. Further, in a case that the dichromat information related to the type of the dichromat inputted by the dichromat information input unit 122 is information of the aforementioned Type-T dichromat, a processing is performed in which, for example, the original color image 600 acquired in the step S501 is converted into a luminance signal, a first color difference signal corresponding to the color difference axis (Y-B) indicated in FIG. 3, and a second color difference signal corresponding to the color difference axis (GC-RM) indicated in FIG. 3.

With regard to processings hereinafter, processings in a case that the dichromat information related to the type of the dichromat inputted by the dichromat information input unit 122 is information of the aforementioned Type-P dichromat or the Type-D dichromat will be described.

Subsequently, in a step S503, the hue conversion unit 124 performs hue conversion of converting a value of the first color difference signal obtained by the conversion processing by the luminance signal/color difference signal conversion unit 123 into a value of the second color difference signal and converting a value of the second color difference signal obtained by the conversion processing by the luminance signal/color difference signal conversion unit 123 into a value of the first color difference signal. The image of processings of the step S503 is the image of the processing in which the hue turns round by 90° as indicated by the arrows in the hue conversion circle of FIG. 3, and can be represented by a formula (1) and a formula (2) below, for example.

(value of second color difference signal)′=(value of first color difference signal) (1)

(value of first color difference signal)′=(value of second color difference signal) (2)

Here, in the formula (1) and the formula (2), a mark ′ indicates a value after a conversion processing by the hue conversion unit 124. Though a case of turning the hue by 90° is shown in the present example, turning by a proper angle near to 90° is not prohibited. However, if the hue is turned by 90° as in the present example, it is possible to simply exchange the value of the first color difference signal and the value of the second color difference signal each other to perform the processing, and as a result a processing load of the hue conversion processing can be reduced, and thus turning the hue by 90° is particularly suitable in the present embodiment.

Further, a turning angle of the hue at a time of converting the value of the first color difference signal into the value of the second color difference signal and at a time of converting the value of the second color difference signal into the value of the first color difference signal is not limited to a vicinity of 90°, either. In other words, it suffices that the turning angle of the hue at the time of converting the value of the first color difference signal into the value of the second color difference signal is an angle preventing a color (for example, Y, B) except the color (for example, G to C, M to R) hard to be distinguished by a dichromat from being an opposite hue of a case that the dichromat visually perceives an original color image. Further, the turning angle of the hue at a time of converting the value of the second color difference signal into the value of the first color difference signal can be determined in correspondence with whether it is intended to emphasize being the image after the conversion processing by the hue conversion unit 124 to a trichromat thereby to perform consensual validation, or it is intended not to make the trichromat conscious of being the image after the conversion processing by the hue conversion unit 124. In other words, by making the turning angle be near 90°, it is possible to make both the trichromat and the dichromat clearly perceive that the image is the image after conversion processing by the hue conversion unit 124, so that consensual validation of a color hard to view and a color easy to view can be done between the trichromat and the dichromat. In other words, in the example of FIG. 3, a reference color difference third axis based on a third color difference signal being a color difference signal of a color pair easy to be perceived by a trichromat and the reference color difference first axis are almost the same. Therefore, if a value of the third color difference signal is converted into a value of the second color difference signal, the second color difference signal after the conversion processing becomes a color difference signal easy to distinguish for the dichromat but becomes a color difference signal hard to distinguish for the trichromat, so that the dichromat can perceive a hue easy to be distinguished by the trichromat and the trichromat can perceive a hue hard to be distinguished by the dichromat. Further, as a result of multiplying the first color difference signal after conversion by −1 as a constant A which will be described later, adding a turning angle of 180° (inversion of axis), and multiplying the first color difference signal after conversion by 0 as a constant A, a feeling of strangeness the trichromat has for the image after conversion processing by the hue conversion unit 124 is reduced, so that it is possible to make the trichromat not to be conscious of being the image after the conversion processing.

Subsequently, in a step S504, the color compression processing unit 126 judges whether or not to execute a color compression processing. More specifically, judgment in the step S504 is judgment of whether or not to execute the color compression processing in correspondence with whether or not color compression instruction information is inputted from the color compression instruction information input unit 125 into the color compression processing unit 126.

As a result of the judgment of the step S504, if the color compression processing is to be executed (S504/YES), the process is proceeded to a step S505.

If the process is proceeded to the step S505, the value of the first color difference signal after conversion obtained by the conversion processing by the hue conversion unit 124 is reduced, and a color compression processing related to the hue of the hue circle indicated in FIG. 3 is performed. The processing of the step S504 is a reduction processing of the value of the first color difference signal after conversion in each hue of the hue circle indicated in FIG. 3, and can be represented by a formula (3) below, for example.

(value of first color difference signal)″=A*(value of first color difference signal) (3)

Here, in the formula (3), a constant A has a value 0≦|A|<<1, and a mark ″ depicts a first color difference signal after conversion/reduction (after color compression) by the color compression processing unit 126.

When the processings of both the steps S503 and S505 are performed, the color difference signal after processing of the step S505 can be represented by a formula (4) and a formula (5) below, made by summing up the formulas (1) to (3).

(value of second color difference signal)′=(value of first color difference signal) (4)

(value of first color difference signal)′=A*(value of second color difference signal) (5)

By the reduction processing of the value of the first color difference signal after the conversion in the step S505, it is possible to make a component of the first color difference signal in each hue of the hue circle indicated in FIG. 3 be constantly 0 (zero) or a value close to 0 (zero), and consequently, the color compression processing is realized. It should be noted that an amplitude adjustment unit can be provided which can adjust the value of the second color difference signal after conversion arbitrarily in conformity with easiness in visual recognition of the dichromat. Thereby, it becomes possible to adjust vividness at a time that the dichromat sees a later-described hue-converted color image.

When the processing of the step S505 is finished or it is judged not to execute the color compression processing in the step S504 (S504/N0), the process is proceeded to a step S506.

When the process is proceeded to the step S506, the hue-converted color image generation unit 127 performs a processing of performing an RGB re-conversion processing based on the luminance signal obtained by the conversion processing of the step S502, and the first color difference signal after conversion and the second color difference signal after conversion which are obtained by the conversion processing of the step S503, thereby to generate a hue-converted color image. Here, the hue-converted color image generated in the step S506 becomes an RGB color image.

More specifically, in the step S506, if it is judged not to execute the color compression processing in the step S504 (S504/NO), the hue-converted color image generation unit 127 performs the RGB re-conversion processing by using the luminance signal obtained by the conversion processing of the step S502 and the first color difference signal after conversion and the second color difference signal after conversion which are obtained by the conversion processing of the step S503, thereby to generate a hue-converted color image.

Further, more specifically, in the step S506, if the color compression processing of the step S505 is performed, there is performed a processing of performing the RGB re-conversion processing by using the luminance signal obtained by the conversion processing of the step S502, the first color difference signal after conversion/reduction (after color compression) obtained by the color compression processing of the step S505, and the second color difference signal after conversion obtained by the conversion processing of the step S503, thereby to generate a hue-converted color image.

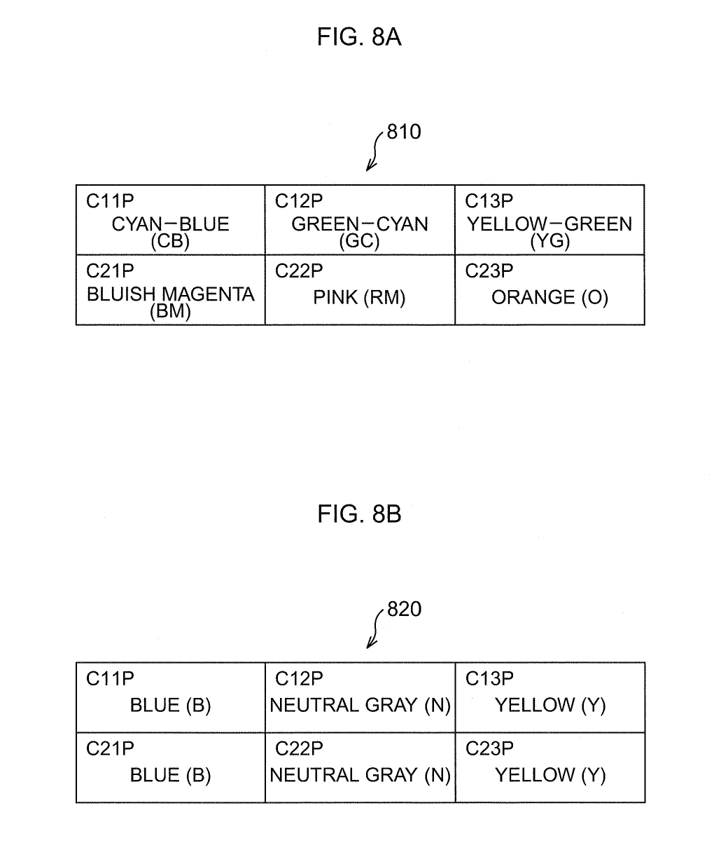

FIG. 8A indicates the embodiment of the present invention, and is a schematic diagram indicating an example of a hue-converted color image 810 generated in the step S506 of FIG. 5 in a case that the hue conversion processing in the step S503 of FIG. 5 is performed and the color compression processing in the step S505 of FIG. 5 is not performed.

FIG. 8A indicates the hue-converted color image 810 made by converting each hue into a hue positioned about turned around by 90° counterclockwise in the hue circle indicated in FIG. 3 by the hue conversion processing in the step S503 of FIG. 5. More specifically, FIG. 8A indicates the hue-converted color image 810 in which the color patch C11 of green (G) indicated in FIG. 6 is hue-converted into a color patch C11P of cyan-blue (CB), the color patch C12 of yellow (Y) indicated in FIG. 6 is hue-converted into a color patch C12P of green-cyan (GC), the color patch C13 of red (R) indicated in FIG. 6 is hue-converted into a color patch C13P of yellow-green (YG), the color patch C21 of cyan (C) indicated in FIG. 6 is hue-converted into a color patch C21P of bluish magenta (BM), the color patch C22 of blue (B) indicated in FIG. 6 is hue-converted into a color patch C22P of pink (RM), and the color patch C23 of magenta (M) indicated in FIG. 6 is hue-converted into a color patch C23P of orange (O).

As described above, it is known that in the hue-converted color image 810 indicated in FIG. 8A, green (G) and cyan (C) of the original color image 600 of FIG. 6, which a trichromat (normal color vision person) perceives as colors with a tinge of green, is converted into cyan-blue (CB) and bluish magenta (BM) being colors with a tinge of blue, when considered in a color pair of Y-B. Similarly, it is known that in the hue-converted color image 810 indicated in FIG. 8A, red (R) and magenta (M) of the original color image 600 of FIG. 6, which a trichromat (normal color vision person) perceives as colors with a tinge of red, is converted into yellow-green (YG) and orange (O) being colors with a tinge of yellow when considered in the color pair of Y-B.

FIG. 8B indicates the embodiment of the present invention, and is a schematic diagram indicating an example of a hue-converted color image 820 generated in the step S506 of FIG. 5 in a case that the hue-conversion processing in the step S503 of FIG. 5 is performed and the color compression processing in the steps S505 of FIG. 5 is performed.

Here, a hue as far as after performing the hue conversion processing in the step S503 of FIG. 5 is the hue of the hue-converted color image 810 indicated in FIG. 8A described above. If the color compression processing in the step S505 of FIG. 5 is further performed from the above state, the value of the first color difference signal in each hue of the hue circle indicated in FIG. 3 is reduced in terms of a reference color difference first axis (α) direction, and the color compression processing is performed. With regard to the hue-converted color image 820 indicated in FIG. 8B, there is indicated a hue-converted color image in a case that the formula (3) and the formula (5) as well as a reduction processing (that is, processing where component of first color difference signal of each hue after the hue conversion in step S503 is 0 (zero)) where a constant A indicated in FIG. 4A is 0 (zero) are performed.

More specifically, in FIG. 8B is indicated the hue-converted color image 820 in which the color patch C11 of green (G) indicated in FIG. 6 is hue-converted into a color patch C11P of blue (B), the color patch C12 of yellow (Y) indicated in FIG. 6 is hue-converted into a color patch C12P of neutral gray (N), the color patch C13 of red (R) indicated in FIG. 6 is hue-converted into a color patch C13P of yellow (Y), the color patch C21 of cyan (C) indicated in FIG. 6 is hue-converted into a color patch C21P of blue (B), the color patch C22 of blue (B) indicated in FIG. 6 is hue-converted into a color patch C22P of neutral gray (N), and the color patch C23 of magenta (M) indicated in FIG. 6 is hue-converted into a color patch C23P of yellow (Y).

In other words, for the Type-P/Type-D dichromat, a color difference component of the reference color difference first axis (α) indicated in FIG. 3 hardly contributes to visual recognition of a color image, and thus, in the color compression processing of the step S505, there is performed a processing of eliminating that color difference component from the hue-converted color image, thereby to generate the hue-converted color image 820 which has only a color contrast of yellow (Y) and blue (B) as indicated in FIG. 8B. By performing the color compression processing of the step S505 of FIG. 5 to generate the hue-converted color image 820 indicated in FIG. 8B, it becomes possible to approximately present color reproduction by a Type-P/Type-D dichromat to a trichromat (normal color vision person) without largely impairing color recognition by the dichromat.

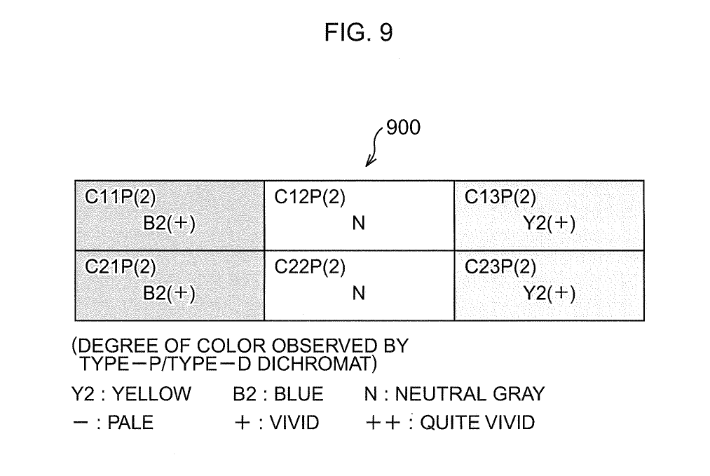

FIG. 9 indicates the present embodiment, and is a schematic diagram indicating an example of a hue-converted color image 900 at a time that a Type-P/Type-D dichromat observes the hue-converted color image 810 indicated in FIG. 8A or the hue-converted color image 820 indicated in FIG. 8B. Here, since FIG. 9 indicates color patches reflected in the eyes of the Type-P/Type-D dichromat at a time of observing, a mark (2) is added to the respective color patches indicated in FIG. 8A or FIG. 8B for discrimination, as a color patch C11P(2) for the color patch C11P indicated in FIG. 8A or FIG. 8B.

More specifically, in the eyes of the Type-P/Type-D dichromat, the color patch C11P of cyan-blue (CB) indicated in FIG. 8A is reflected as a color patch C112(2) of vivid blue (B2(+)) indicated in FIG. 9, the color patch C12P of green-cyan (GC) indicated in FIG. 8A is reflected as a color patch C12P(2) of neutral gray (N) indicated in FIG. 9, and the color patch C13P of yellow-green (YG) indicated in FIG. 8A is reflected as a color patch C139(2) of vivid yellow (Y2(+)) indicated in FIG. 9. Further, in the eyes of the Type-P/Type-D dichromat, the color patch C21P of bluish magenta (BM) indicated in FIG. 8A is reflected as a color patch C21P(2) of vivid blue (B2(+)) indicated in FIG. 9, the color patch C222 of pink (RM) indicated in FIG. 8A is reflected as a color patch C22P(2) of neutral gray (N) indicated in FIG. 9, and the color patch C23P of orange (O) indicated in FIG. 8A is reflected as a color patch C23P(2) of vivid yellow (Y2(+)) indicated in FIG. 9.

It should be noted that also in a case that the Type-P/Type-D dichromat visually perceives respective color patches of the hue-converted color image 820 indicated in FIG. 8B, color patches are those indicated in FIG. 9, similarly to in a case that the Type-P/Type-D dichromat visually perceives the respective color patches of the hue-converted color image 810 indicated in FIG. 8A.

The Type-P/Type-D dichromat distinguishes colors of the aforementioned original color image 600 of FIG. 6 in an upper and lower direction as indicated in the original color image 700 of FIG. 7, but distinguishes colors of the hue-converted color image indicated in FIG. 8A or FIG. 8B as a contrast of colors in a right and left direction as indicated in the hue-converted color image 900 of FIG. 9. The direction is the direction (right and left direction) similar to the color pair in which the trichromat (normal color vision person) first perceives the original color image 600 of FIG. 6. In other words, it indicates that though a color shade itself is different from that of perception by the trichromat (normal color vision person), the Type-P/Type-D dichromat becomes able to perceive a contrast of red and green for the trichromat.

Here, FIG. 5 will be explained again.

When the processing of the step S506 of FIG. 5 is finished, the process is proceeded to a step S507.

When the process is proceeded to the step S507, the image displaying control unit 129, in accordance with image switching instruction information inputted from the image switching instruction information input unit 128, performs control to alternatively display the original color image acquired in the step S501 and the hue-converted color image generated in the step S506 in the display section 107 in a manner to be able to be visually perceived by a dichromat related to dichromat information inputted from the dichromat information input unit 122 at the same viewpoint.

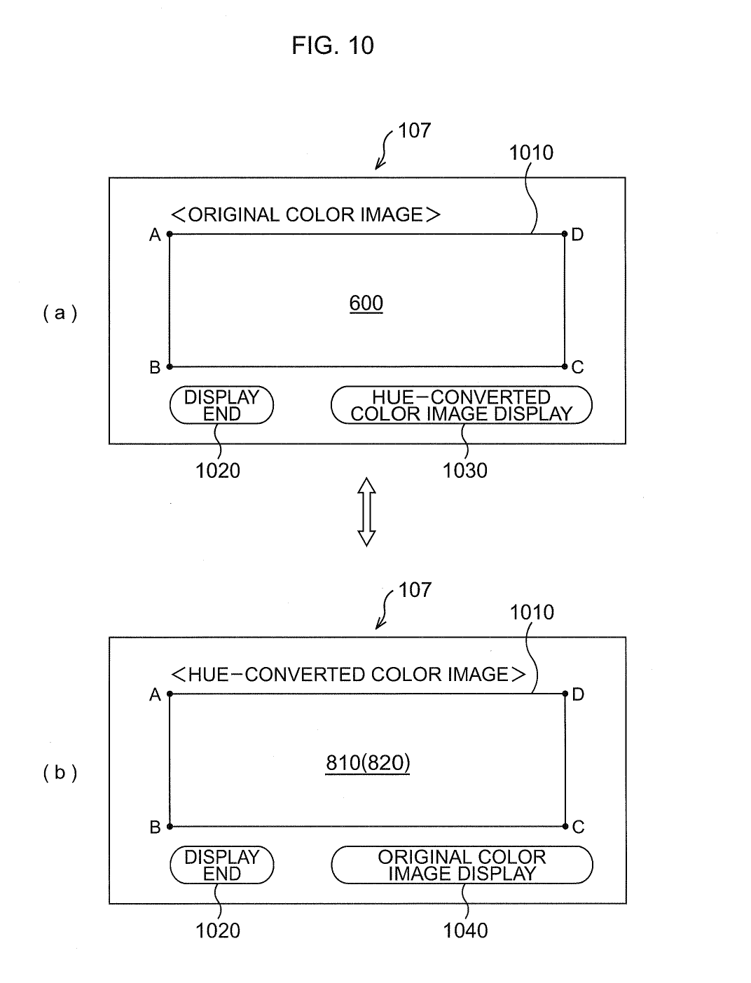

FIG. 10 indicates the embodiment of the present invention, and is a schematic diagram indicating an example of a state in which the original color image and the hue-converted color image are alternatively displayed in the display section 107 by the image displaying control processing in the step S507 of FIG. 5.

A part (α) of FIG. 10 indicates an example of an original color image display screen displayed in the display section 107. In the original color image display screen, the original color image (600 of FIG. 6) acquired in the step S501 of FIG. 5 is displayed in an image display region 1010, and other than that, a display end button 1020 and a hue-converted color image display button 1030 are provided. Here, if the display end button 1020 is operated, image display to the display section 107 ends, and if the hue-converted color image display button 1030 is operated, a hue-converted color image display screen indicated in a part (b) of FIG. 10 is displayed in the display section 107.

The part (b) of FIG. 10 indicates an example of the hue-converted color image display screen displayed in the display section 107. In the hue-converted color image display screen, the hue-converted color image (810 of FIG. 8A or 820 of FIG. 8B) generated in the step S506 of FIG. 5 is displayed in the image display region 1010, and other than that, the display end button 1020 and the original color image display button 1040 are provided. It should be noted that in the part (b) of FIG. 10, a configuration of a function similar to a configuration indicated in the part (a) of FIG. 10 is given the same reference numeral. Here, when the original color image display button 1040 is operated, the original color image display screen indicated in the part (a) of FIG. 10 is displayed in the display section 107.

In FIG. 10, the display end button 1020, the hue-converted color image display button 1030, and the original color image display button 1040 are formed by, for example, a transparent touch panel or the like provided on the display section 107, and is equivalent to the input device 106 indicated in FIG. 1. Further, the hue-converted color image display button 1030 and the original color image display button 1040 constitute the image switching instruction information input unit 128 indicated in FIG. 2.

Further, in the present embodiment, the image display region 1010 of the part (a) of FIG. 10 to display the original color image 600 and the image display region 1010 of the part (b) of FIG. 10 to display the hue-converted color image 810 or 820 are the same in terms of coordinate positions depicted by each A to D. In other words, in the present embodiment, the original color image 600 acquired in the step S501 and the hue-converted color image 810 or 820 generated in the step S506 are to be alternatively displayed in the display section 107 in a manner to be able to be visually perceived by a dichromat at the same viewpoint.

It should be noted that though in the example indicated in FIG. 10, the hue-converted color image display button 1030 and the original color image display button 1040 are used as the image switching instruction information input unit 128 thereby to display the original color image 600 and the hue-converted color image 810 or 820 in a manner to be able to be visually perceived at the same viewpoint, the present invention is not limited to this mode. For example, a mode is also applicable in which in the same window, as an image switching instruction information input unit 128, a tab for displaying an original color image and a tab for displaying a hue-converted color image are provided, the corresponding image is displayed with time in the image display region 1010 in correspondence with selection of each tab, and the respective images are alternatively displayed in a manner to be able to be visually perceived at the same viewpoint.

Here, an operation and effect of a case that the original color image 600 and the hue-converted color image 810 or 820 are alternatively displayed in a manner to be able to be visually perceived at the same viewpoint in the present embodiment will be described below.

In the present embodiment, when the hue-converted color image 810 or the like is generated by performing hue conversion of the original color image 600, a hue conversion processing of a part of an image region in the original color image 600 is not performed but a hue conversion processing is performed to the entire original color image 600. Thereby, in the present embodiment, compared with a case that a part of the image region of the original color image 600 is subjected to a hue conversion processing, a processing such as extracting the part of image region and the like becomes unnecessary, so that a processing load related to a hue conversion processing can be reduced.

However, in the case of the present embodiment, if a hue-converted color image 810 or 820 only is merely presented to a Type-P/Type-D dichromat, as a result that a hue conversion processing is performed, a color pair (color pair based on second color difference signal) distinguishable in an original color image 600 becomes a color pair (color pair based on first color difference signal) hard to be distinguished in the hue-converted color image 810 or 820. Thus, in order to avoid such a situation, in the present embodiment, it is configured that an original color image 600 and a hue-converted color image 810 or 820 are able to be alternatively displayed, so that, by presenting both the original color image 600 and the hue-converted color image 810 or 820 to a dichromat, hues of the original color image 600 can be instructed complementarily to the dichromat. In other words, by observing the original color image 600 and the hue-converted color image 810 or 820 in combination, the dichromat becomes able to viscerally understand a “structure of two pairs of color contrasts including degrees of vividness of colors” perceived by a trichromat, thereby to perform distinction.

On this occasion, with regard to color saturation, as a result that the Type-P/Type-D dichromat feels a degree of vividness of yellow and blue of the hue-converted color image, the dichromat can viscerally grasp a degree of color difference between red and green felt by a trichromat. Further, with regard to hues of yellow and blue, it suffices to follow a color sense the dichromat himself has.

Further, the dichromat becomes able to understand color names easily by considering a logical correspondence while bringing a hue circle to mind.

In a case of the trichromat, it is possible to subjectively judge a ratio of a component (reference color difference first axis (α) of FIG. 3) of red-green in the broad sense of the term and a component (reference color difference second axis (β) of FIG. 3) of yellow-blue, for all the hues. For example, if the trichromat can feel 50% of red and 50% of yellow, a color is judged to be orange (O), and if the trichromat can feel 50% of red and 50% of blue, a color is judged to be purple. The Type-P/Type-D dichromat, copying the above, can follow a color sense the dichromat himself has with regard to yellow and blue and substitute the color sense of yellow and blue in the hue-converted color image for red and green for the trichromat.

As a concrete example, when the Type-P/Type-D dichromat observes, if an image region (C11(2) and C13(2)) with a tinge of pale yellow in the original color image 700 of FIG. 7 becomes more yellowish (C13P(2)) in the hue-converted color image 900 of FIG. 9, it can be judged to be red (C13 in example of FIG. 6) in the color sense of the trichromat, and, in contrast, if the image region turns bluish (C11P(2)) in the hue-converted color image 900 of FIG. 9, it can be judged to be green (C11 in example of FIG. 6) in the color sense of the trichromat. Similarly, when the Type-P/Type-D trichromat observes, if an image region (C21(2) and C23(2)) with a tinge of pale blue in the original color image 700 of FIG. 7 becomes more bluish (C21P(2)) in the hue-converted color image 900 of FIG. 9, it can be judged to be cyan (C21 in the example of FIG. 6) in the color sense of the trichromat, and, in contrast, if the image region turns yellowish (C23P(2)) in the hue-converted color image 900 of FIG. 9, it can be judged to be magenta (C23 in example of FIG. 6) in the color sense of the trichromat.

Further, in the present embodiment, as indicated in FIG. 10, when both screens of the original color image 600 and the hue-converted color image 810 or 820 are alternatively displayed, alternatively displaying is performed in a manner to be able to be visually perceived by the dichromat at the same viewpoint. By performing alternatively displaying in a manner that the dichromat can visually perceive both images at the same viewpoint, compared with a case that both images are displayed in the same screen and the both images are observed, a case that both images are printed out in a piece of paper or the both images are printed out in each piece of paper and the both images are observed (that is, the both images cannot be visually perceived at the same viewpoint), for example, a relation among each hue of the both images can be presented to the dichromat in a clearer form, when the dichromat performs the aforementioned complementary perception processing to each hue of the both images.

As described above, a basic gist of the invention of the application is, to convert a color pair (including their color saturation) of an original color image which is able to be distinguished by a trichromat but is hard to be distinguished by a dichromat into a color pair (including their color saturation) able to be distinguished by the dichromat, to generate a hue-converted color image, and to alternatively display the hue-converted color image and the original color image, whereby a one-dimensional color difference space the dichromat fundamentally has is easily expanded to a two-dimensional color difference space the trichromat has, so that the dichromat is assisted in perceptual judgment of a hue of the original color image. Further, the invention of the application is highly compatible with general image/video system, with a television system in particular, and can assure a simple and real-time execution speed.

According to the above-described present embodiment, it is possible to provide a mechanism enabling a dichromat being a color deficient person to grasp a hue of an original color image while suppressing a processing load of an image processing in the original color image.

### Other Embodiments

Further, the present invention is also realized by executing a processing below.

In other words, it is a processing in which software (program) to realize a function of the aforementioned embodiment is provided to a system or a device via a network or various storage media, and a computer (or CPU, MPU or the like) of that system or device reads out and execute the program.

The program and a computer-readable storage medium storing the program is included in the present invention.

Further, though the example in which the image capturing device is applied as the image processing device is explained in the aforementioned embodiment, the image processing device according to the present invention is not limited to this mode. For example, a mode is also applicable in which a configuration except the image capturing section 105 indicated in FIG. 1 is configured as an image processing device and an image capturing section 105 is provided out of the image processing device, and an original color image from the image capturing section 105 is processed in the image processing device.

Further, in the aforementioned embodiment, though the example in which the color patches are used as the object H is explained for the sake of simplicity of explanation, the present invention is not limited to this mode, and it is also possible to apply, for example, a general landscape, a person and the like as an object H.

It should be noted that the above-described embodiment of the present invention merely illustrates concrete examples of implementing the present invention, and the technical scope of the present invention is not to be construed in a restrictive manner by these embodiments. That is, the present invention may be implemented in various forms without departing from the technical spirit of main features thereof.

### INDUSTRIAL APPLICABILITY

Among five senses (visual sense, auditory sense, tactile sense, gustatory sense, and olfactory sense) of a human being, the visual sense is particularly important to live in a modern society. Further, nowadays it is a matter of fact that the number of color deficient persons, related to the visual sense, is not negligible at all. The present invention presents a hue of an original color image to the color deficient person in a manner to be able to be grasped, and assists the color deficient person to live sensitively in the modern society.

1. An image processing device performing a processing of an original color image and performing control to alternatively display at least two kinds of images including the original color image in a manner to be able to be visually perceived by a dichromat at the same viewpoint, the image processing device comprising:
a first conversion unit converting the original color image into a luminance signal, a first color difference signal being a color difference signal of a color pair hard to be distinguished by the dichromat, and a second color difference signal being a color difference signal of a color pair easy to be distinguished by the dichromat;
a second conversion unit performing hue conversion of converting a value of the first color difference signal obtained by a conversion processing by said first conversion unit into a value of the second color difference signal and converting a value of the second color difference signal obtained by the conversion processing by said first conversion unit into a value of the first color difference signal;
an image generation unit generating a hue-converted color image based on the luminance signal obtained by the conversion processing by said first conversion unit and the first color difference signal after conversion and the second color difference signal after conversion which are obtained by a conversion processing by said second conversion unit; and
an image displaying control unit performing control to alternatively display the original color image and the hue-converted color image in a manner to be able to be visually perceived by the dichromat at the same viewpoint.

2. The image processing device according to claim 1, wherein, in said second conversion unit, when a turning angle of a hue at a time of converting the value of the first color difference signal obtained by the conversion processing by said first conversion unit into the value of the second color difference signal is determined, the turning angle of the hue is determined in a manner that a color other than a color hard to be distinguished by the dichromat does not become of a hue opposite to a hue in a case of visually recognizing the original color image

3. The image processing device according to claim 1,
wherein, in said second conversion unit, at a time of converting the value of the second color difference signal obtained by the conversion processing by said first conversion unit into the value of the first color difference signal, it is determined whether conversion is performed at a turning angle of a hue of near to 90° or the value of the first color difference signal after conversion is further converted at a turning angle of a hue of 180°.

4. The image processing device according to claim 1, further comprising:
a color compression unit performing a color compression processing by reducing the value of the first color difference signal after conversion obtained by the conversion processing by said second conversion unit,
wherein said image generation unit generates the hue-converted color image by using the luminance signal obtained by the conversion processing by said first conversion unit, the first color difference signal after reduction obtained by the color compression processing by said color compression processing unit, and the second color difference signal after conversion obtained by the conversion by said second conversion unit.

5. The image processing device according to claim 4,
wherein said color compression processing unit performs the color compression processing by reducing a value of the first color difference signal after conversion obtained by the conversion processing by said second conversion unit to 0 (zero).

6. The image processing device according to claim 4, further comprising:
an amplitude adjustment unit capable of arbitrarily adjusting the value of the second color difference signal after conversion obtained by the conversion processing by said second conversion unit to cope with visibility of the dichromat,
wherein said image generation unit generates the hue-converted color image by using the luminance signal obtained by the conversion processing by said first conversion unit, the first color difference signal after reduction obtained by the color compression processing by said color compression processing unit, and the second color difference signal after conversion adjusted by said amplitude adjustment unit.

7. The image processing device according to claim 1, further comprising:
an amplitude adjustment unit capable of arbitrarily adjusting the value of the second color difference signal after conversion obtained by the conversion processing by said second conversion unit to cope with visibility of the dichromat,
wherein said image generation unit generates the hue-converted color image by using the luminance signal obtained by the conversion processing by said first conversion unit, the first color difference signal after conversion obtained by the conversion processing by said second conversion unit, and the second color difference signal after conversion adjusted by said amplitude adjustment unit.

8. The image processing device according to claim 1,
wherein, in a hue circle, a first axis based on the first color difference signal and a second axis based on the second color difference signal are orthogonal to each other.

9. The image processing device according to claim 1, further comprising:
a dichromat information input unit to input dichromat information related to a type of the dichromat,
wherein said first conversion unit sets the first color difference signal and the second color difference signal in correspondence with the dichromat information.

10. The image processing device according to claim 1,
wherein a first axis based on the first color difference signal is almost the same as a third axis based on a third color difference signal being a color difference signal of a color pair easy to be distinguished by a trichromat.

11. The image processing device according to claim 10, further comprising
a third conversion unit converting a value of the third color difference signal into a value of the second color difference signal.

12. An image processing method by an image processing device performing a processing of an original color image and performing control to alternatively display at least two kinds of images including the original color image in a manner to be able to be visually perceived by a dichromat at the same viewpoint, the method comprising the steps of:
first converting of converting the original color image into a luminance signal, a first color difference signal being a color difference signal of a color pair hard to be distinguished by the dichromat, and a second color difference signal being a color difference signal of a color pair easy to be distinguished by the dichromat;
second converting of performing hue conversion of converting a value of the first color difference signal obtained by a conversion processing by said first converting into a value of the second color difference signal and converting a value of the second color difference signal obtained by the conversion processing by said first converting into a value of the first color difference signal;
image generating of generating a hue-converted color image based on the luminance signal obtained by the conversion processing by said first converting and the first color difference signal after conversion and the second color difference signal after conversion which are obtained by a conversion processing by said second converting; and
image displaying controlling of performing control to alternatively display the original color image and the hue-converted color image in a manner to be able to be visually perceived by the dichromat at the same viewpoint.

13. A program product for causing a computer to execute an image processing method by an image processing device performing a processing of an original color image and performing control to alternatively display at least two kinds of images including the original color image in a manner to be able to be visually perceived by a dichromat at the same viewpoint, the program product comprising:
computer readable code means for executing first converting of converting the original color image into a luminance signal, a first color difference signal being a color difference signal of a color pair hard to be distinguished by the dichromat, and a second color difference signal being a color difference signal of a color pair easy to be distinguished by the dichromat;
computer readable code means for executing second converting of performing hue conversion of converting a value of the first color difference signal obtained by a conversion processing by said first converting into a value of the second color difference signal and converting a value of the second color difference signal obtained by the conversion processing by said first converting into a value of the first color difference signal;
computer readable code means for executing image generating of generating a hue-converted color image based on the luminance signal obtained by the conversion processing by said first converting and the first color difference signal after conversion and the second color difference signal after conversion which are obtained by a conversion processing by said second converting; and
computer readable code means for executing image displaying controlling of performing control to alternatively display the original color image and the hue-converted color image in a manner to be able to be visually perceived by the dichromat at the same viewpoint.
